(19) United States
(12) Patent Application Publication
(10) Pub. No.: US 2001/0009033 A1
(43) Pub. Date: Jul. 19, 2001

(54) Object-oriented business system and method

(76) Inventors: Masatoshi Morisaki, Kawasaki (JP); Hiroyuki Yoshida, Kawasaki (JP)

Correspondence Address: STAAS & HALSEY LLP, 700 11TH STREET, NW, SUITE 500, WASHINGTON, DC, 20001, US

(21) Appl. No.: 09/791,917

(22) Filed: Feb. 26, 2001

Related U.S. Application Data
(63) Continuation of application No. PCT/JP99/01154, filed on Mar. 10, 1999.

(30) Foreign Application Priority Data
Oct. 22, 1998 (JP) 10-300690

(51) Int. Cl. G06F 9/44

(52) U.S. Cl. 717/1

(57) ABSTRACT

A domain object stores a business rule, and an object management is provided with an interface for data access. A service object executes a service requested by other objects. A control object controls the collaboration relationship among these objects according to the process request from a client, and notifies the client of the process result.

### CROSS REFERENCE TO RELATED APPLICATION

This application is a continuation of International PCT Application No. PCT/JP99/01154 filed on Mar. 10, 1999.

### BACKGROUND OF THE INVENTION

1. Field of the Invention

The present invention relates to a business system for managing information about resources, such as slips, goods, etc., and integrating necessary business in a distribution industry, etc., and a method thereof.

2. Description of the Related Art

Recently, a slip processing system for integrating process business, such as the issuance of order slips, the inventory management of goods, the issuance of shipping orders, the issuance of invoices, the receipt of payment, etc., has been introduced mainly into a distribution industry. Such an information processing system is called an ERP (enterprise resource planning) system.

Conventionally, object-orientation was not considered to be suitable for the organization of a variety of business application systems including such a slip processing system (Nikkei Computer, pp. 209-217, Jun. 22, 1998). Objects are usually composed of capsulated data and a procedure (method) for the data.

If a business process is analyzed in an object-oriented way and a model is organized using object components, according to a conventional system, only a part of the entire system actually corresponds to pure objects, and other objects are degenerated objects without data. Therefore, as a result, the features of object-orientation could not be utilized, and thereby the easiness in modeling a real problem, the re-use of components, the capsulation of data and a method, improvement in customizability, improvement in maintainability, improvement in quality and improvement in productivity were not achieved.

For example, when a slip processing business is analyzed in an object-oriented way, where should a boundary between objects be set and in what grain size should each object be designed are very vague. A boundary between objects means a boundary between pieces of data or methods stored in the objects, a grain size means the size of data or a method.

There is no appropriate guide on the degree of abstraction for making easy the re-use of an object, and thereby interaction between objects cannot be simplified. Therefore, flexibility such that objects can be re-composed depending on a business process, is not secured. Since an object cannot be abstracted sufficiently, inheritance and versatility, which are the features of an implementation language cannot be effectively utilized, which is also a problem.

Furthermore, in a relational database system indispensable for a slip processing business, uniqueness of a record is guaranteed, while in the world of objects, the existence of a plurality of objects storing the same data is allowed. Therefore, it is difficult to design a boundary between the worlds of a relational database system and objects, and thereby it is difficult to guarantee the compatibility of data and to realize a transaction control over a plurality of objects.

### SUMMARY OF THE INVENTION

An object of the present invention is to provide a business system which is organized by uniting object-oriented components, for utilizing the features of object-orientation and a method thereof.

A business system according to the present invention comprises an object unit and an execution unit.

The object unit is provided with a domain object storing a business rule, and an object management managing the domain object and implementing an interface for data access. The execution unit executes a process corresponding to the business rule using both the domain object and object management.

### BRIEF DESCRIPTION OF DRAWINGS

FIG. 1 shows the principle of a business system of the present invention.

FIG. 2 shows the configuration of the business system.

FIG. 3 shows the classes of business objects.

FIG. 4 shows the functions of a slip processing business.

FIG. 5 shows examples of the classes.

FIG. 6 shows the first link relationship.

FIG. 7 shows the first pattern.

FIG. 8 shows the second link relationship.

FIG. 9 shows the second pattern.

FIG. 10 shows the third link relationship.

FIG. 11 shows the third pattern.

FIG. 12 shows the fourth link relationship.

FIG. 13 shows the fourth pattern.

FIG. 14 shows the fifth link relationship.

FIG. 15 shows the fifth pattern.

FIG. 16 shows the sixth link relationship.

FIG. 17 shows the sixth pattern.

FIG. 18 shows the seventh link relationship.

FIG. 19 shows the seventh pattern.

FIG. 20 shows the eighth link relationship.

FIG. 21 shows the eighth pattern.

FIG. 22 shows a screen for order input.

FIG. 23 shows examples of instances.

FIG. 24 shows a procedure for creating an object management.

FIG. 25 is an implementation pattern for acquiring an object.

FIG. 26 is the first implementation pattern for releasing an object.

FIG. 27 is the second implementation pattern for releasing an object.

FIG. 28 shows the configuration of an information processing apparatus.

FIG. 29 shows examples of storage media.

### DESCRIPTION OF PREFERRED EMBODIMENTS

A detailed preferred embodiment according to the present invention is described below with reference to the drawings.

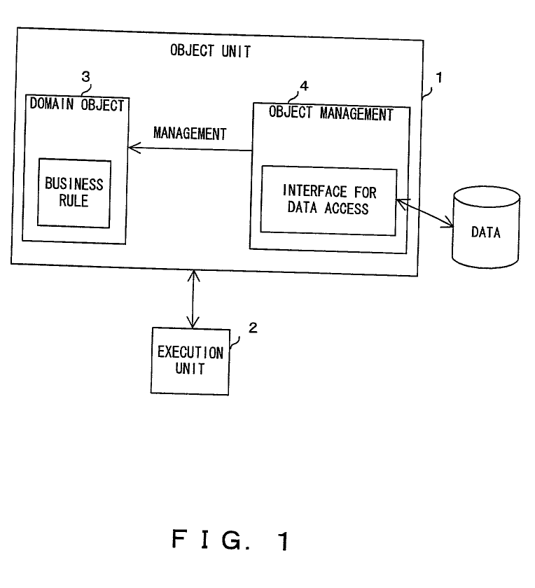

FIG. 1 shows the principle of a business system of the present invention. The business system shown in FIG. 1 comprises an object unit 1 and an execution unit 2. The object unit 1 includes both a domain object 3 for storing a business rule and an object management 4 equipped with an interface for data access. The execution unit 2 executes a process corresponding to the business rule using the domain object 3 and object management 4.

The business rule stored by the domain object 3 corresponds to a method prepared based on a business transaction procedure, and describes a primitive process related to both the data setting of the domain object 3 and an operational logic. The object management 4 is another object different from the domain object 3, and the interface for data access stored by the object management 4 corresponds to a method for accessing a database, sequential file, etc., stored in an auxiliary storage device.

In this way, the business rule and the interface for data access can be implemented independently by separating an object storing the interface for data access from an object storing the business rule. Since by separating an object storing the interface for data access from an object storing the business rule the degree of abstraction of each object can be improved and the grain size can also be reduced, the interaction between objects can be simplified. Since the business rule and the interface for data access are segmented independently, either of the business rule and interface can be replaced, and thereby the flexibility of a system can be improved. Furthermore, since the object management 4 takes charge of a process related to data access, there is no need for the domain object 3 to be implemented separately depending on access targets, such as database, etc. In this way, since the object management 4 conceals a database, etc., from the domain objects 3, the boundary between the worlds of databases and objects becomes clear.

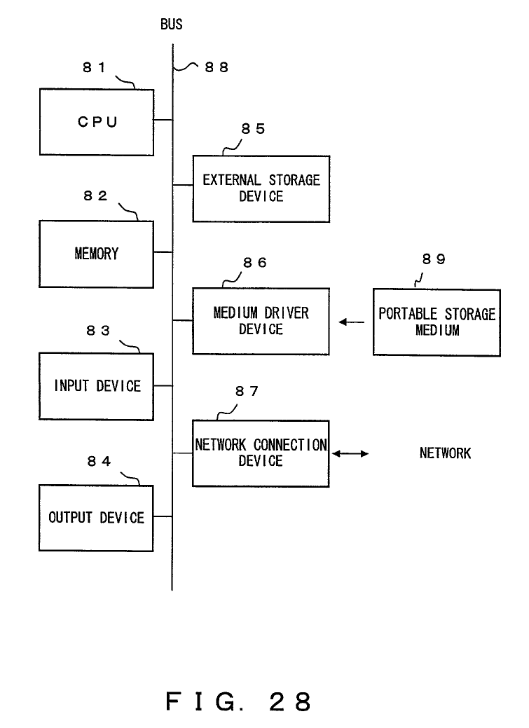

The object management 4, for example, is provided with an interface suitable for at least one of a target for data access and the access method, and is used in combination with the domain object 3. For example, the object unit shown in FIG. 1 corresponds to the memory 82 shown in FIG. 28, which is described later, and the execution unit 2 shown in FIG. 1 corresponds to the CPU (central processing unit) 81 shown in FIG. 28.

In this preferred embodiment, both the grain size of each object component to be used in combination and the functions and system of an object positioned on a boundary between a business application and a client screen or between a business application and a database system are clarified, and the entire slip processing business is expressed with an aggregate of objects. At that time, both links between objects and interface for communications are simplified by applying the object components to a specific pattern and extracting/designing the components.

Specifically, a place where a business rule is implemented, a place where a system for realizing performances related to data access, etc., and a place where the scope of transaction is defined are clearly separated as object components, and both a standard relationship between the object components and a standard communications procedure are set in such a way that the modification in implementation of each component can be made independently.

Each of the object components is designed in a specific degree of abstraction and in a specific grain size based on a predetermined analysis pattern, and both the contents and interfaces of the components are structured based on both a predetermined design pattern and an implementation pattern. Therefore, the modification of an application due to the recomposition of components and the modification of an application due to the modification of the content of a component can be easily made.

If a business rule, the scope of transaction, or requirement on database access or a cache is modified, a component to be corrected can be easily specified and be corrected without affecting components other than a target component. A new component development based on the inheritance of objects can be easily attained, and the combination of a new component and an existing component can be satisfactorily made.

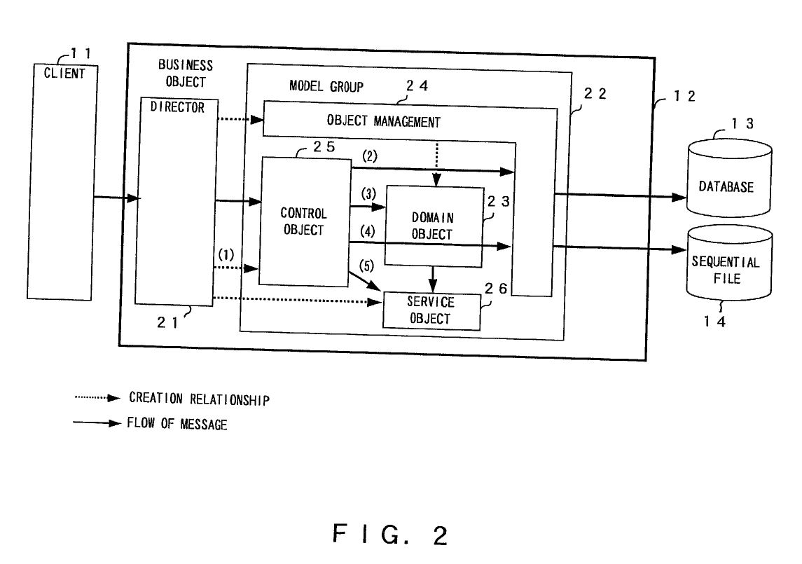

FIG. 2 shows the configuration of a business system in this preferred embodiment. The business system shown in FIG. 2 is configured using a computer, such as a workstation, etc., and comprises a client 11, a business object 12, a database 13 and a sequential file 14. The database 13 and sequential file 14 are stored in separate auxiliary storage devices.

The client 11 corresponds to an input/output unit which becomes a user interface, and the business object 12 corresponds to an aggregate of object components. These object components are expanded in the memory of a system. For the database 13, for example, a relational database is used.

The business object 12 includes both a director 21 and a model group 22. The director 21 is middleware for a communications layer and controls communications between the client 11 and model group 22. The objects of the model group 22 are classified into a document object 23, an object management (object manager) 24, a control object 25 and a service object 26.

The domain object 23 corresponds to a class extracted as “article”, such as a slip, goods, etc., when a business analysis is made. A class corresponds to the definition of the structure of an object. A specific object with a structure defined by a class is called an instance.

The domain object 23 also has both a business rule on stored data and the execution procedure of a method. The business rule is a method created based on a business logic indicating a business transaction procedure, and mainly describes a primitive process for the setting of values and operation logic. The domain object 23 also carries out both the reception of an exception notice and a state transition.

The object management 24 is a class prepared to manage a domain object 23 which requires to be made persistent in the database 13, sequential file 14, etc., and is used in combination with a corresponding domain object 23. To make data persistent means to store data in an auxiliary storage device.

The object management 24 is also the creation source of a domain object 23, and carries out the creation, deletion, aggregation and reuse of a domain object 23. The object management 24 is provided with the same interface as that of the domain object 23.

The object management 24 is also a proxy for access external data, and has a method for an input/output logic. This input/output logic describes the type of an access target and a process according to the access type, and is separated from a business rule.

For the access target, a data cache and a variety of auxiliary storage devices are used. The data cache is a mechanism to keep storing a domain object in a memory and immediately returning information about the object without accessing an auxiliary storage device if the object is referenced.

The access type varies depending on the data structure of an access target, etc. The object management 24, for example, accesses the database 13 using an SQL (Structured Query Language), and carries out the retrieval, addition, deletion and update of data. The object management 24 sequentially accesses the sequential file 14 and executes the reads/write process. Furthermore, the object management 24 executes an input/output process using different performance improvement algorithms according to which of an online process, a batch process and a master maintenance process a system carries out. The master maintenance process corresponds to a process of updating the static data of a domain object, etc., and for the performance improvement algorithm, an algorithm for a data cache or database access is used.

The combination of a variety of input/output logic is usually designated by the sub-class of the object management 24, and the object management 24 of a specific sub-class is used depending on processes.

The control object 25 corresponds to a class extracted as “manpower”, “business”, “application”, “screen” or etc., and has a link relationship with the domain object 23, object management 24 and service object 26. The control object 25 also has both a business rule and the execution procedure of a method concerning a collaboration relationship among the domain objects 23.

The control object 25 also processes a process request from the client 11 inputted via the director 21 based on the stored link relationship. In this case, the control object 25 controls the collaboration relationship among objects according to the business rule, and notifies the client 11 of the process result.

In this way, the control object 25 joints a plurality of objects both high in the degree of abstraction and small in grain size, controls the flow of a process as an application, and regulates the scope of the session of a transaction extended over a plurality of databases. Then, the control object 25 collectively executes the exit process of an error occurred during the process.

Furthermore, the control object 25 carries out the management of a transaction, the exception notice reception of a model, type conversion and protocol conversion between the client 11 and model group 22, the assembly/disassembly of data, etc.

Although the service object 26 corresponds to a class similar to that of the domain object 23, the service object 26 does not require persistency in an auxiliary storage device and does not have a corresponding object management 24. The service object 26 mainly performs a specific function requested by another object as a service.

If the domain object 23 has a business rule common to a business type, a system can be customized using a service object 26 independent of a domain object 23. In this case, the service object 26 is provided with an interface in which customization is presumed, and the system is configured in such a way that an individual user can incorporate the business rule later.

The dotted arrow marks in the business object 12 indicate the creation relationship of an object. The object management 24, control object 25 and service object 26 are created by the director 21, and the domain object 23 is created by a corresponding object management 24.

The solid arrow marks in the business object 12 indicate the flow of a message between objects. Message (1) corresponds to a method publicized to the client 11, message (2) corresponds to reference to a logic table, and message (3) corresponds to the data setting of the domain object 23. Message (4) corresponds to the request for the creation, update and deletion, etc., of the domain object 23 and message (5) corresponds to a service request to the service object 26.

In this way, the domain object 23 is provided with a business rule, the object management 24 is provided with the input/output logic of data corresponding to the business rule and the control object 25 is provided with a business rule for controlling a collaboration relationship as a transaction.

Therefore, the input/output logic is clearly separated from the business rule, and a variety of input/output logic can be combined with one business rule by replacing the object management 24.

However, in a conventional system, there is no clear boundary between a business rule and an input/output logic, both the business rule and input/output logic are often buried in one object. Therefore, it is difficult to add/delete either of the business rule and input/output logic, which was a problem.

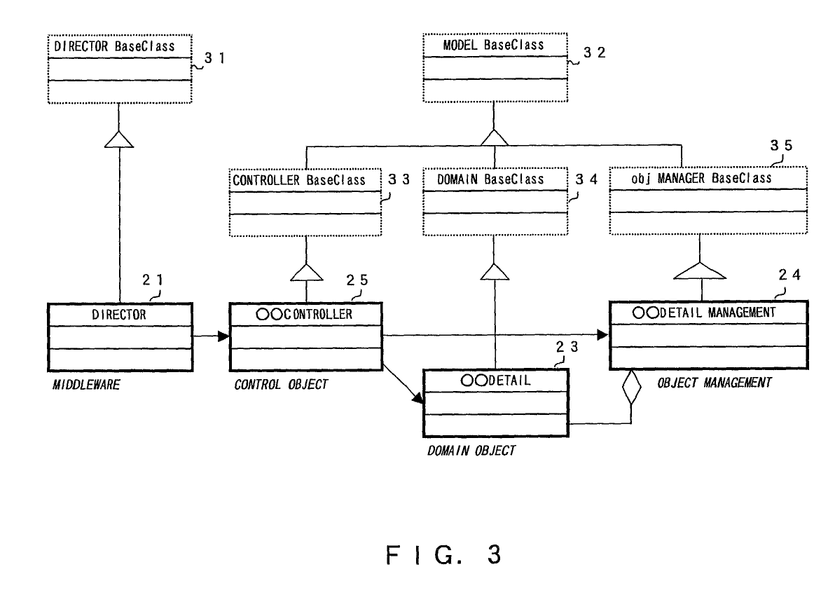

FIG. 3 shows the architecture of the classes of the director 21, domain object 23, object management 24 and control object 25.

In the hierarchical relationship shown in FIG. 3, a director base class 31 is the higher-order class of the director 21 (super class), and a model base class 32 is the higher-order class of a controller base class 33, domain model base class 34 and object manager base class 35. The controller base class 33, domain model base class 34 and object manager base class 35 are the higher-order classes of the control object 25, domain object 23 and object management 24, respectively.

Since in the hierarchical relationship among classes, a lower-order class generally succeeds the definition of an higher-order class, the control object 25, domain object 23 and object management 24 are created based on the definitions of the controller base class 33, domain model base class 34 and object manager base class 35, respectively.

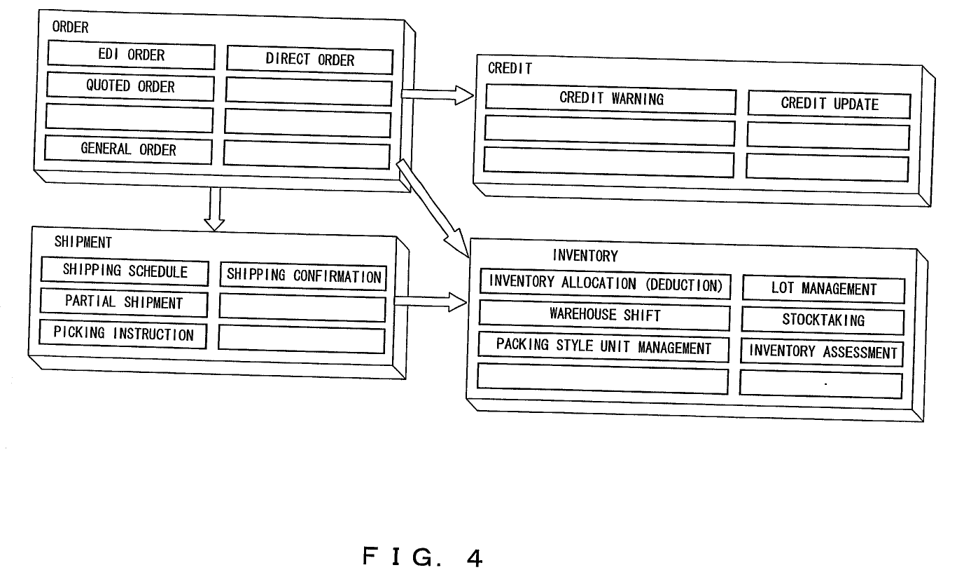

However, in the case of a slip processing business, the functions as shown in FIG. 4 are required as the basic functions of a business system. In FIG. 4, there are “order”, “shipment”, “credit” and “inventory” as basic functions. “Order” starts the three other functions, and the “shipment” starts the “inventory”. These functions are provided corresponding to a slip or goods, and can be used as classes of objects.

“Order” includes each function of “EDI (electronic data interchange) order”, “direct order”, “quoted order” and “general order”, and “shipment” includes each function of “shipping schedule”, “shipping confirmation”, “partial shipment” and “picking instruction”. “Credit” includes each function of “credit warning” and “credit update”, and “inventory” includes each function of “inventory allocation (deduction)”, “lot management”, “warehouse shift”, “stocktaking”, “packing style unit management” and “inventory assessment”.

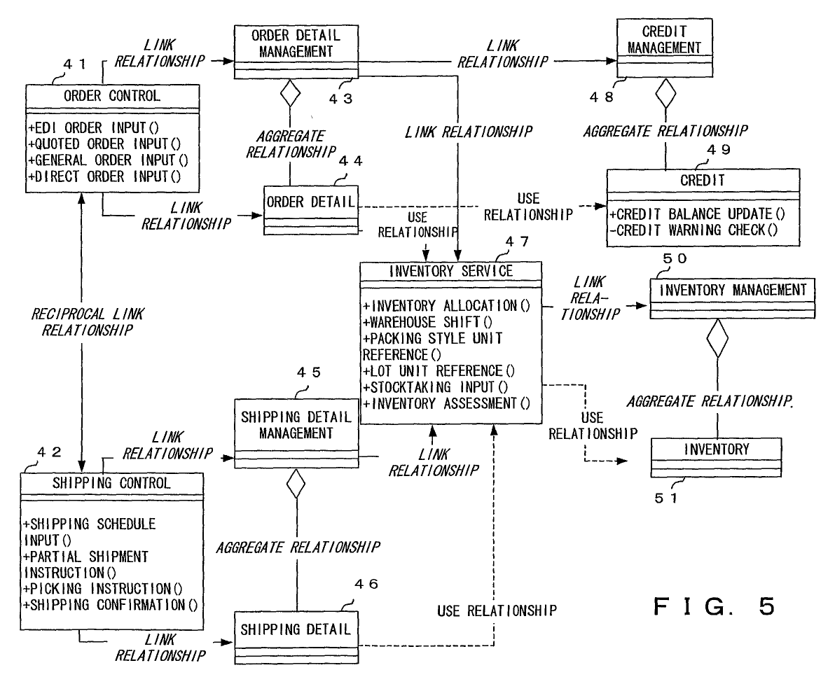

In order to realize these basic functions, for example, the classes shown in FIG. 5 are provided. In this example, classes of an order control 41, a shipping control 42, an order detail management 43, an order detail 44, a shipping detail management 45, a shipping detail 46, an inventory service 47, a credit management 48, a credit 49, an inventory management 50 and an inventory 51 are provided.

Of these classes, the order control 41 and shipping control 42 correspond to the class of the control object, and the order detail management 43, shipping detail management 45, credit management 48 and inventory management 50 correspond to the class of the object management. The order detail 44, shipping detail 46, credit 49 and inventory 51 correspond to the class of the domain object, and the inventory service 47 corresponds to the class of the service object.

The order control 41 stores each method of EDI order input (), quoted order input (), general order input () and direct order input (), and shipping control 42 stores each method of shipping schedule input (), partial shipment instruction (), picking instruction () and shipping confirmation ().

The inventory service 47 stores each method of inventory allocation (), warehouse shift (), packing style unit reference (), lot reference (), stocktaking input () and inventory assessment (), and the credit 49 stores each method of credit balance update () and credit warning check (). Of these methods, a method with a symbol “+” attached corresponds to a public method in OMT (object modeling technique) notation.

A solid arrow marks indicates a link relationship, and for example, the order control 41 stores a link to the order detail management 43. A dotted arrow mark indicates a use relationship, and for example, the order detail 44 uses functions of credit 49 and inventory service 47, if required. A solid line with a diamond mark indicates an aggregate relationship, and for example, one object of the class of the order detail management 43 stores reciprocal link relationships with one or more objects of the class of the order detail 44.

A link relationship is set, for example, by making a link source object store a pointer indicating a link destination object. In the case of a reciprocal link relationship, each of two objects stores a pointer indicating the other object.

Actually, besides these classes, a lot of classes, such as goods, goods management, customer, customer management, etc., are provided. A business system is organized by relating those classes to one another using a link relationship or a use relationship. A slip process system for realizing a partial function, such as an order input system, shipping instruction system, sales amount calculation system, etc., can also be organized by combining only a part of the classes.

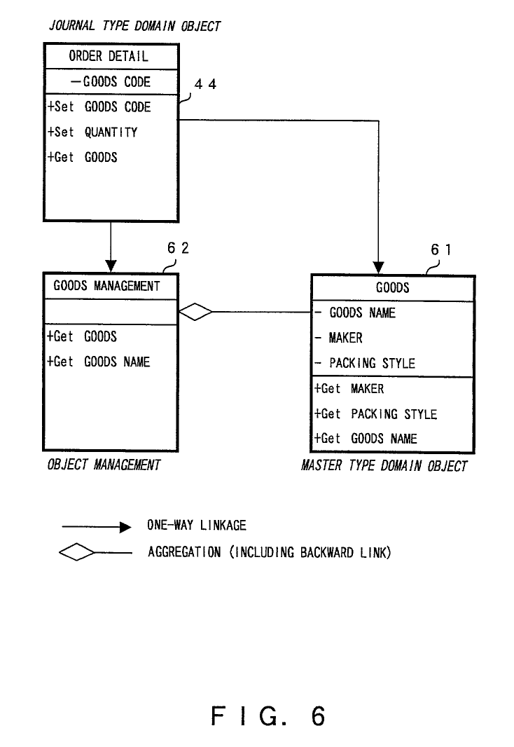

Next, both an example of the link relationship of objects and an example of an analysis pattern used to design the objects are described with reference to FIGS. 6 through 19. Although a design pattern and an implementation pattern are more specific than the analysis pattern, the basic configurations of the design and implementation patterns are the same as the analysis pattern.

FIG. 6 shows link relationships among objects for explaining a message between the objects. If an object requests another object to execute a method, generally the object transmits a message including the name of the method to the requesting object.

In FIG. 6, the order detail 44 corresponds to a journal type domain object which is used to read/write data, and the goods 61 corresponds to a master type domain object which is mainly used only to read data. The goods management 62 is an object management managing the goods 61. The order detail 44 stores two one-way links; one link pointing the goods 61 and the other pointing the goods management 62. The goods management 62 and the goods 61 are in the aggregate relationship described above.

Since a domain object corresponds to a class extracted as “article”, the domain object stores both the attribute data and method of “article”. The attribute is extracted from CRC (class responsibility & collaboration) card analysis or items of a database. CRC card analysis is a method for analyzing a business to be systematized in an object-oriented way, and a link relationship among an attribute, a method and a class, etc., can be extracted using a CRC card in which responsibility and the collaboration class are written for each class. The method of the domain object corresponds to the setting of an attribute value, reference, a business rule, a calculation expression, etc.

In this example, the order detail 44 stores “goods code” as an attribute, and stores “Set goods code”, “Set quantity” and “Get goods” as methods. The goods 61 stores “goods name”, “maker” and “packing style” as attributes, and stores “Get goods name”, “Get maker” and “Get packing style” as methods. The goods management 62 stores “Get goods” and “Get goods name” as methods. “Get goods name”, “Get maker” and “Get packing style” stored by the goods 61 correspond to the business rules of a domain object.

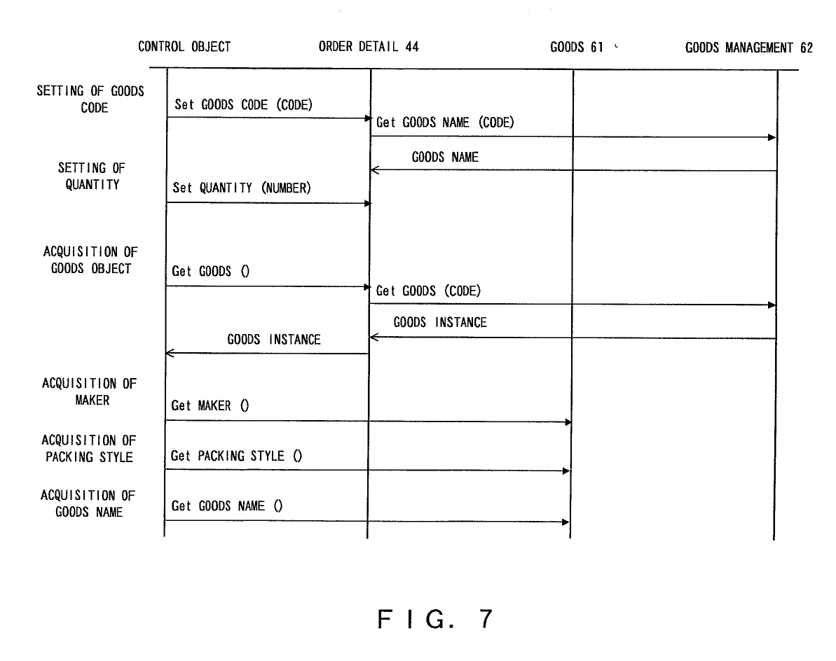

FIG. 7 shows operation patterns implemented by these objects. In this example, six patterns of the setting of a goods code, the setting of quantity, the acquisition of goods object, the acquisition of a maker, the acquisition of a packing style and the acquisition of a goods name are shown.

If in the setting of a goods code, a control object transmits a message of Set goods code (code) to the order detail 44, the order detail 44 executes the Set goods code (code), and sets a given goods code. Then, the order detail 44 transmits a message of Get goods name (code) to the goods management 62, the goods management 62 executes the Get goods name (code) and returns a goods name corresponding to the goods code to the order detail 44. In this way, if the order detail 44 sets a goods code, the order detail 44 automatically acquires a corresponding goods name from the goods management 62.

Then, if in the setting of quantity, the control object transmits a message of Set quantity (number) to the order detail 44, the order detail 44 executes the Set quantity (number) and sets a given number.

Then, if in the acquisition of a good object, the control object transmits a message of Get goods () to the order detail 44, the order detail 44 transmits a message of the Get goods (code) to the goods management 62. The goods management 62 executes the Get goods (code), the goods management 62 returns the information about a corresponding goods 61 (instance) to the order detail 44, and the order detail 44 returns the information to the control object. Then, the control object can transmit a message to the goods 61 based on the returned information.

Then, if in the acquisition of a maker, the control object transmits a message of Get maker () to the goods 61, the goods 61 executes the Get maker () and returns a maker name to the control object.

Then, if in the acquisition of a packing style, the control object transmits a message of Get packing style () to the goods 61, and the goods 61 executes the Get packing style () and returns a packing style to the control object.

Then, if in the acquisition of a goods name, the control object transmits a message of Get goods name () to the goods 61, and the goods 61 executes the Get goods name () and returns a goods name to the control object.

In this way, a journal type domain object can acquire a master type domain object by itself and can communicate with the object. A control object can acquire a master type domain object via a journal type domain object or an object management and acquire necessary information from the object.

In the pattern shown in FIG. 7, since the data access type of goods management 62 is not specified, this pattern can be applied regardless of whether data are stored in a relational database or a sequential file or whether data is processed online or in a batch. An actually used input/output logic is designated as the sub-class of the goods management 62 at the time of compilation, and is reflected on an execution program.

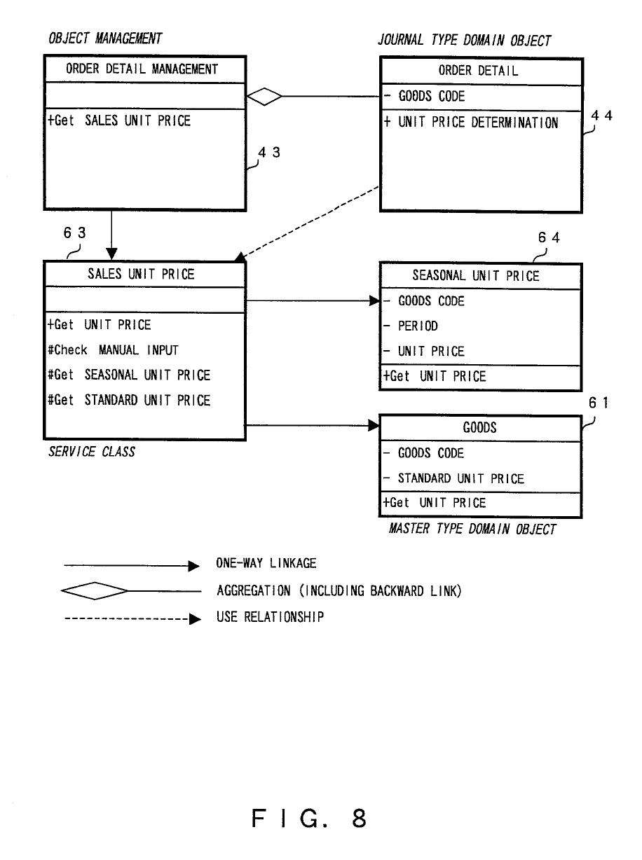

FIG. 8 shows link relationships among objects for explaining a service object. The service object corresponds to a class obtained by separating a method portion from a domain object and making the portion independent, and can be a component alone. The service object is also provided with a general interface or a lot of interfaces for offering a service to a plural kinds of domain objects. The service object can also reference a master type domain object required when a business rule is executed. Furthermore, the service object does not have an attribute requiring persistency in an auxiliary storage device and does not requires any object management.

In FIG. 8, a sales unit price 63 is a service object, and a seasonal unit price 64 is a master type domain object. The order detail management 43 stores a link pointing the sales unit price 63, and the sales unit price 63 stores a link pointing both the seasonal unit price 64 and the goods 61. The order detail management 43 and the order detail 44 are in an aggregate relationship, and the order detail 44 uses the sales unit price 63. In this way, a service object used by a domain object is held by a corresponding object management.

In this example, the order detail management 43 stores “Get sales unit price” as a method. The order detail 44 stores “goods code” and “unit price determination” as an attribute and a method, respectively.

The sales unit 63 stores “Get unit price”, “Check manual input”, “Get seasonal unit price” and “Get standard unit price” as methods. The seasonal unit price 64 stores “goods code”, “period” and “unit price” as attributes, and stores “Get unit price” as a method. The goods 61 stores “goods code” and “standard unit price” as attributes, and stores “Get unit price” as a method.

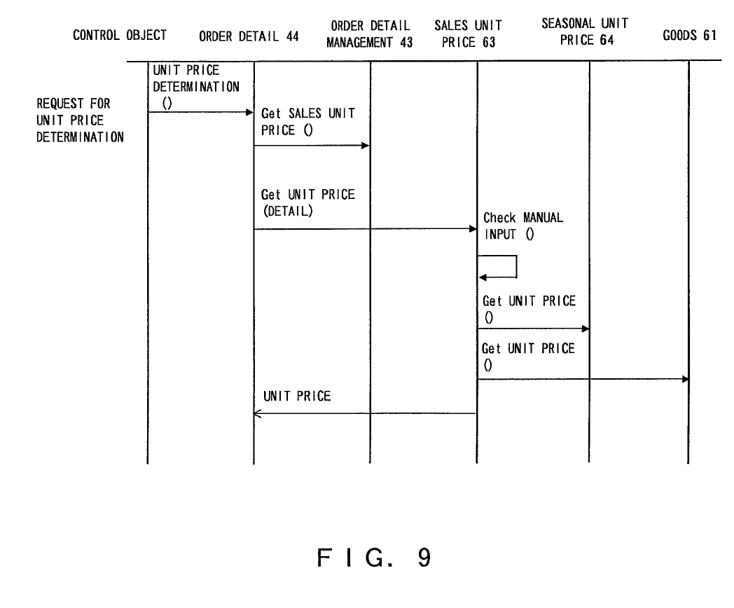

FIG. 9 shows one of the patterns of operations implemented by these objects. In this example, a pattern of requesting a unit price determination is shown. First, if a control object transmits a message of unit price determination () to the order detail 44, the order detail 44 transmits a message of Get sales unit price () to the order detail management 43, and transmits a message of Get unit price (detail) to the sales unit price 63. The order detail management 43 executes the Get sales unit price (), and the sales unit price 63 executes the Get unit price (detail).

At this time, the sales unit price 63 executes Check manual input () and transmits a message of the Get unit price () to both the seasonal unit price 64 and goods 61. Both the seasonal unit price 64 and goods 61 execute the Get unit price () and returns a corresponding unit price to the sales unit price 63. The sales unit price 63 returns the corresponding unit price to the order detail 44.

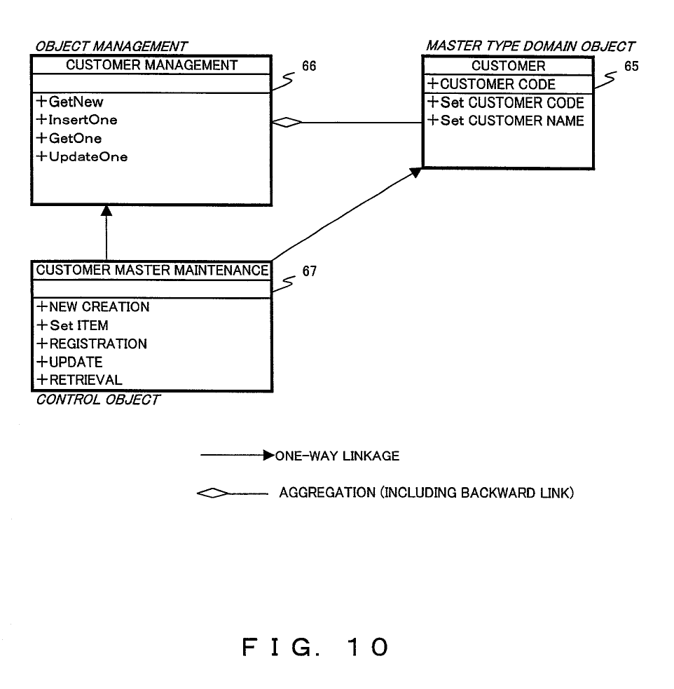

FIG. 10 shows link relationships among objects for explaining the instance management by an object management. An object management is provided with interfaces for creation (GetNew), acquisition (GetOne), addition (InsertOne) and update (UpdateOne) of an instance of a domain object, and all of these interfaces are unified by the object management.

“GetOne”designates the key attribute of the domain object, acquires one corresponding instance from a cache or auxiliary storage device, and returns information about the instance. “InsertOne” registers the instances of a newly created domain object one by one. “UpdateOne” updates the instances of an existing domain object one by one.

The object management conceals measures against memory leak, the reuse of instance, the guaranty of instance uniqueness and the mechanism of a data cache. The mechanism of a data cache keeps storing a created/acquired object in a memory, and in response to the “GetOne” designating the same key attribute as that of the object, the mechanism returns information about the object without accessing the auxiliary storage device. Since the object management stores no inherent attribute nor business rule inside, the application ratio of an implementation pattern is 100%.

In FIG. 10, a customer 65 is a master type domain object, and a customer management 66 is the object management of the customer 65. A customer master maintenance 67 is a control object implementing the maintenance of the customer 65. The customer master maintenance 67 stores a link to the customer 65 and customer management 66, and the customer management 66 and the customer 65 are in an aggregate relationship.

In this example, the customer management 66 stores “GetNew”, “InsertOne”, “GetOne” and “UpdateOne” as methods. The customer 65 stores “customer code” as an attribute, and stores “Set customer code” and “Set customer name” as methods. The customer master maintenance 67 stores “new creation”, “Set item”, “registration” and “update” as methods.

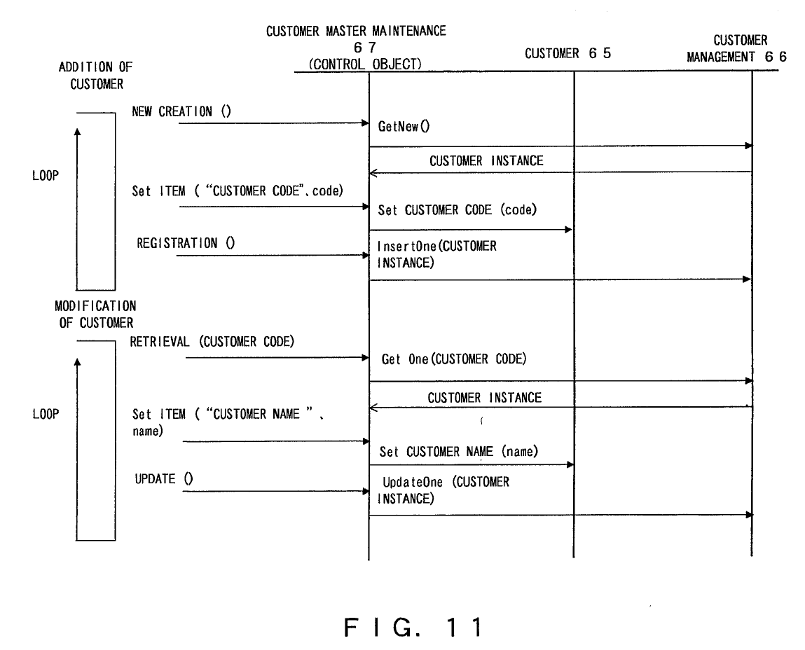

FIG. 11 shows the patterns of operations implemented by these objects. In this example, the patterns of both a customer addition and a customer modification are shown. These patterns are repeated as a loop process necessary times.

In the customer addition, first, on receipt of a message of new creation (), the customer master maintenance 67 executes the new creation ()and transmits a message of GetNew () to the customer management 66. The customer management 66 executes the GetNew (), creates the instance of the customer 65 and returns the information to the customer master maintenance 67.

Then, if the customer master maintenance 67 receives a message of Set item (“customer code”, code), executes the Set item (“customer code”, code) and transmits a message of Set customer code (code) to the customer 65. Then, the customer 65 executes the Set customer code (code) and sets a customer code.

Then, on receipt of a message of registration (), the customer master maintenance 67 executes the registration () and transmits a message of InsertOne (customer instance) to the customer management 66. Then, the customer management 66 executes the InsertOne (customer instance) and adds the customer 65 to a database.

In the customer modification, first, on receipt of a message of retrieval (customer code), the customer master maintenance 67 executes the retrieval (customer code) and transmits a message of GetOne (customer code) to the customer management 66. The customer management 66 executes the GetOne (customer code), acquires the instance of the customer 65 from the database and returns the information to the customer master maintenance 67.

Then, on receipt of a message of Set item (“customer name”, name), the customer master maintenance 67 executes the Set item (“customer name”, name) and transmits a message of Set customer name (name) to the customer 65. Then, the customer 65 executes the Set customer name (name) and sets a customer name.

Then, on receipt of a message of update (), the customer master maintenance 67 executes the update () and transmits a message of UpdateOne (customer instance) to the customer management 66. Then, the customer management 66 executes the UpdateOne (customer instance) and updates the customer 65 registered in the database.

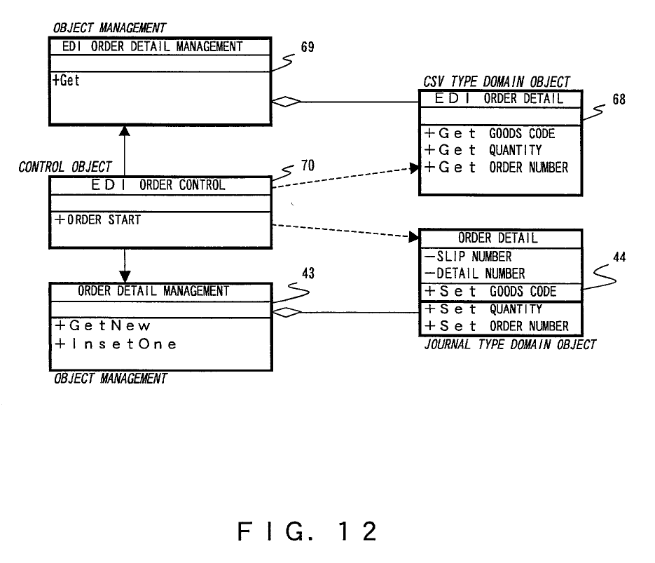

FIG. 12 shows link relationships among objects for explaining the persistency destination concealment by an object management. Although the implementation (execution program) of an object management varies depending on the data structure in an auxiliary storage device of the persistency destination, interfaces for creation, acquisition and addition of an instance of a domain object are unified among different data structures.

For the data structure, a CSV (comma separated value) format file is also used in addition to the relational database and sequential file which are described above. Since interfaces on the domain object side do not depend on the data structure of the persistency destination, the implementation to distinguish the data structures is not necessary for a control object.

In FIG. 12, an EDI order detail 68 is a CSV type domain object corresponding to an order detail of an order received via a line, and an EDI order detail management 69 is the object management of the EDI order detail 68. An EDI order control 70 stores a link to both the EDI order detail management 69 and order detail management 43, and the EDI order detail management 69 and the EDI order detail 68 are in an aggregate relationship. The EDI order control 70 uses both the EDI order detail 68 and order detail 44, and the order detail 44 uses the EDI order detail 68.

In this example, the EDI order detail management 69 stores “Get” as a method, and the EDI order control 70 stores “order start” as a method. The EDI order detail 68 stores “Get goods code”, “Get quantity” and “Get order number” as methods. The order detail management 43 stores “GetNew” and “InsertOne” as methods. The order detail 44 stores “slip number” and “detail number” as attributes and stores “Set goods code”, “Set quantity” and “Set order number” as methods.

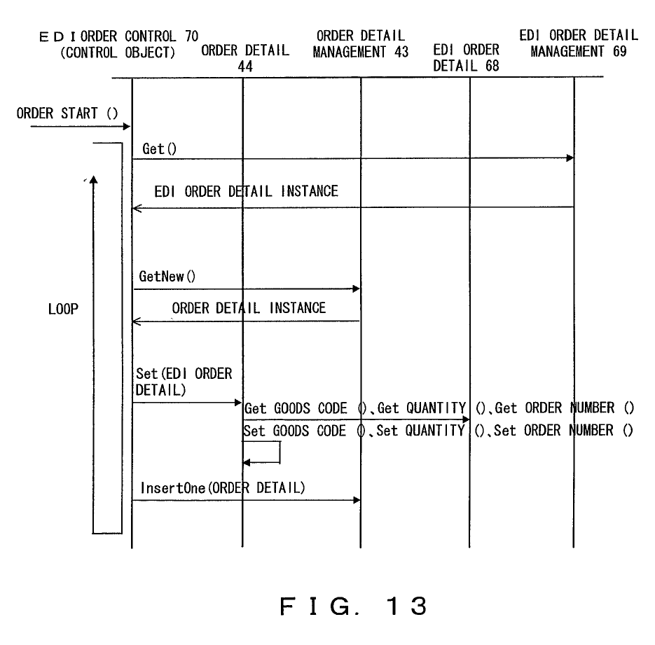

FIG. 13 shows one of the patterns of operations performed by these objects. In this example, a pattern of creating the order journal of a relational database from the order information of a sequential file is shown. This pattern is repeated as a loop process necessary times. This pattern is not a simple shift of data, but corresponds to the business rule of the classes of both an EDI order detail 68 and order detail 44.

First, on receipt of a message of order start (), the EDI order control 70 executes the order start () and transmits a message of Get () to the EDI order detail management 69. The EDI order detail management 69 executes the Get (), acquires the instance of the EDI order detail 68 from a sequential file and returns the information to the EDI order control 70.

Then, the EDI order control 70 transmits a message of GetNew () to the order detail management 43. The order detail management 43 executes the GetNew (), creates the instance of the order detail 44 and returns the information to the EDI order control 70.

Then, the EDI order control 70 transmits a message of Set (EDI order detail) to the order detail 44, and the order detail 44 executes the Set (EDI order detail). Then, the order detail 44 transmits a messages of Get goods code (), Get quantity () and Get order number () to the EDI order detail 68, and the EDI order detail 68 returns a goods code, quantity and an order number to the order detail 44. The order detail 44 executes Set goods code (), Set quantity () and Set order number () and sets the returned information.

Then, the EDI order control 70 transmits a message of InsertOne (order detail) to the order detail management 43. The order detail management 43 executes the InsertOne (order detail) and adds the order detail 44 to a database.

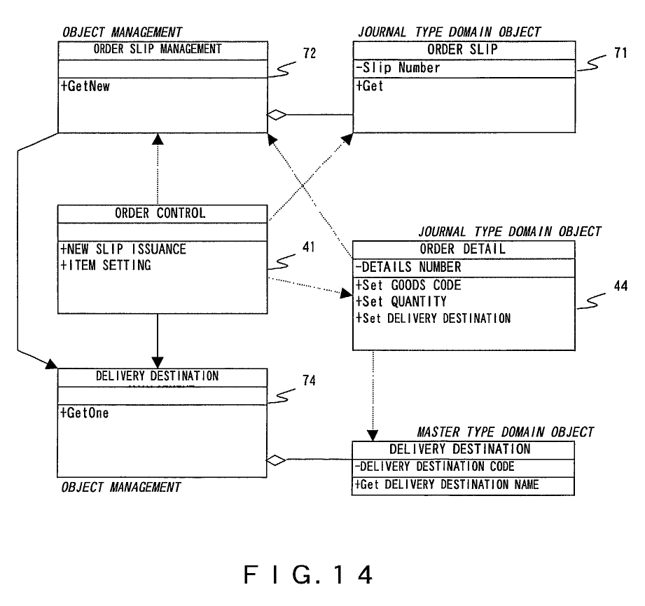

FIG. 14 shows link relationships among objects for explaining both the instance uniqueness guaranty and life cycle control by an object management. An object management aggregates and holds the created instances of a domain object, and prevents the instance of a master type domain object with the same key being doubly created. In this way, the data matching of a domain object is guaranteed.

However, in a conventional system, the uniqueness of instances is not always guaranteed and it is allowed to doubly create an instance with the same key. Therefore, data matching is not guaranteed when data are updated, which is a problem.

Each domain object has a reference counter inherited from the above-described domain model base class, and this reference counter is controlled by an object management. A reference counter is widely used to realize the correct life cycle of an object, and the reference counter stores the number of other objects holding the object in a link relationship.

If the value of the reference counter is 1 when a control object holding an domain object in a link relationship, etc., requests an object management to release the domain object, the object management immediately releases the domain object from a memory. However, if the value of the reference counter is 2 or more, the object management decrements the value by one and leaves the domain object in the memory.

By both the use of such an object management and the strict enforcement of a design pattern, memory leak and a memory error due to the creation and deletion of an instance can be prevented. By both the guaranty of instance uniqueness and the use of a reference counter, the frequency of communications with a database can be reduced.

In FIG. 14, an order slip 71 is a journal type domain object, and an order slip management 72 is the object management of the order slip 71. A delivery destination 73 is a master type domain object, and a delivery destination management 74 is the object management of the delivery destination 73.

The order slip management 72 stores a link to the delivery destination management 74, and the order control 41 stores a link to the order slip management 72. The order slip management 72 and the order slip 71 are in an aggregate relationship, and the delivery destination management 74 and the delivery destination 73 are in an aggregate relationship. Furthermore, the order slip 71 and the order detail 44 are in an aggregate relationship, and an instance of the order slip 72 is linked to one or more instances of the order detail 44. The order control 41 uses both the order slip 71 and order detail 44, and the order detail 44 uses both the order slip management 72 and delivery destination 73.

In this example, the order slip management 72 stores “GetNew” as a method, and the order slip 71 stores “Get” as a method. The order control 41 stores “new slip issuance” and “item setting” as methods. The order detail 44 stores “detail number” as an attribute and stores “Set goods code”, “Set quantity” and “Set delivery destination” as methods. The delivery destination management 74 stores “GetOne” as a method. The delivery destination 73 stores “delivery destination code” as an attribute and stores “Get delivery destination name” as a method.

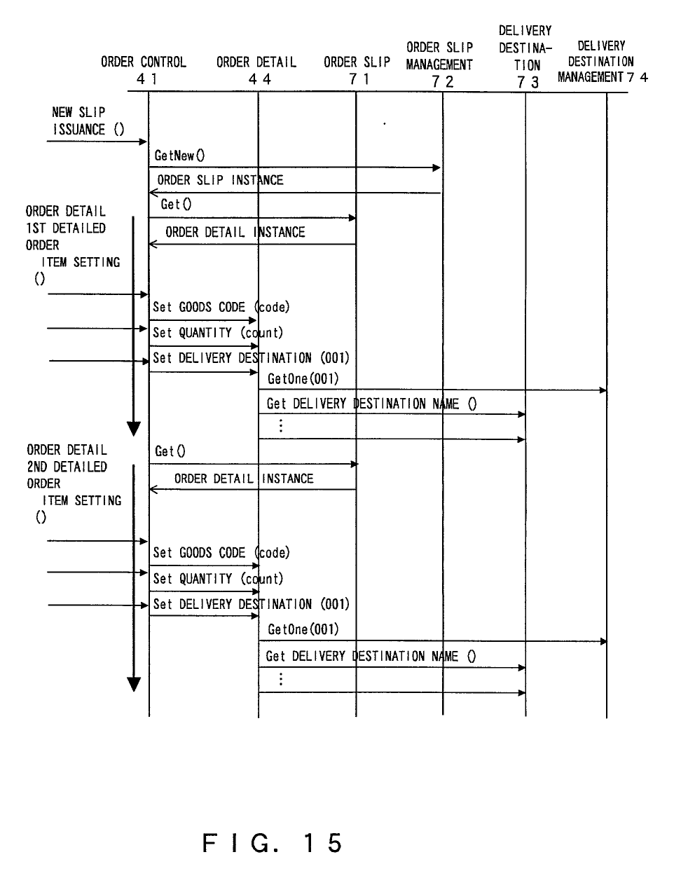

FIG. 15 shows one of the patterns of operations performed by these objects. In this example, a pattern of issuing an order slip 71 and setting the items of the order detail 44 is shown.

First, on receipt of a message of new slip issuance () the order control 41 executes the new slip issuance () and transmits a message of GetNew () to an order slip management 72. The order slip management 72 executes the GetNew (), creates the instance of the order slip 71 and returns the information to the order control 41.

Then, the order control 41 transmits a message of Get () to the order slip 71, acquires the first instance of the order detail 44 and returns the information to the order control 41.

Then, on receipt of a message of item setting (), the order control 41 executes the item setting () and transmits a message of Set goods code (code) to the order detail 44. Then, the order detail 44 executes the Set goods code (code) and sets a goods code.

Then, on receipt of a message of the item setting (), the order control 41 executes the item setting () and transmits a message of Set quantity (count) to the order detail 44. Then, the order detail 44 executes the Set quantity (count) and sets quantity.

Then on receipt of a message of the item setting (), the order control 41 executes the item setting () and transmits a message of Set delivery destination (001) to the order detail 44. Then, the order detail 44 executes the Set delivery destination (001) and sets a delivery destination.

At this time, the order detail 44 transmits a message of Getone (001) to a delivery destination management 74. Then, the delivery destination management 74 executes the GetOne (001), acquires the instance of the delivery destination 73 corresponding to a delivery destination code “001” from a database and returns the information to the order detail 44. Then, the order detail 44 transmits a message of Get delivery destination name () to the delivery destination 73. Then, the delivery destination 73 executes the Get delivery destination name (), acquires a delivery destination name and returns the delivery destination name to the order detail 44.

Then, the order control 41 transmits a message of Get () to the order slip 71. The order slip 71 executes the Get (), acquires the second instance of the order detail 44 and returns the information to the order control 41. Then, the goods code, quantity and delivery destination are set in the order detail 44 according to the same pattern as in the case of the first instance.

Such a pattern is repeated times equivalent to the number of the instances of the order detail 44. During that time the instance uniqueness of the delivery destination 73 is guaranteed by the delivery destination management 74, and the delivery destination 73 is repeatedly reused until the setting of the order detail 44 for one order slip 71 is completed.

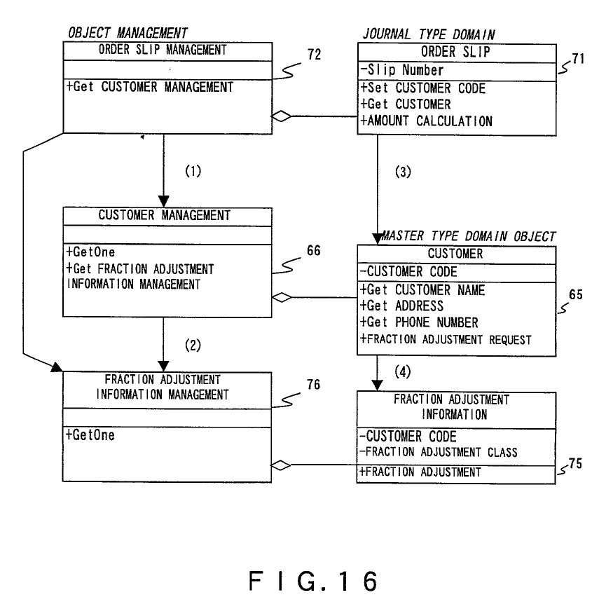

FIG. 16 shows link relationships among objects for explaining the control among the instances of object management. In FIG. 16, a fraction adjustment information 75 is a master type domain object, and a fraction adjustment management 76 is the object management of the fraction adjustment information 75.

The order slip management 72 stores a link (1) pointing a customer management 66, and the customer management 66 stores a link (2) pointing the fraction adjustment information management 76. An order slip 71 stores a link (3) pointing a customer 65, and the customer 65 stores a link (4) pointing the fraction adjustment information 75. The order slip management 72 and the order slip 71 are in an aggregate relationship, and the customer management 66 and the customer 65 are in an aggregate relationship. Furthermore, the fraction adjustment information management 76 and the fraction adjustment information 75 are in an aggregate relationship.

Although an object management is generally created and stored by the director described earlier, at that time, a link between object managements, such as links (1) and (2) is established by the director. A journal type object management stores a link to a related master type object management such as link (1). A link between master type object managements with the same key, such as link (2), is defined, if required.

Although a domain object does not usually create another domain object, the domain object can store a dynamic link to another domain object, such as links (3) and (4), via an object management.

In FIG. 16, the order slip management 72 stores “Get customer management” as a method. The order slip 71 stores “slip number” as an attribute, and stores “Set customer code”, “Get customer” and “amount calculation” as methods. The customer management 66 stores “GetOne” and “Get fraction adjustment information management” as methods. The customer 65 stores “customer code” as an attribute and stores “Get customer name”, “Get address”, “Get phone number” and “fraction adjustment request” as methods.

The fraction adjustment information management 76 stores “GetOne” as a method. The fraction adjustment information 75 stores “customer code” and “fraction adjustment class” as attributes and stores “fraction adjustment” as a method.

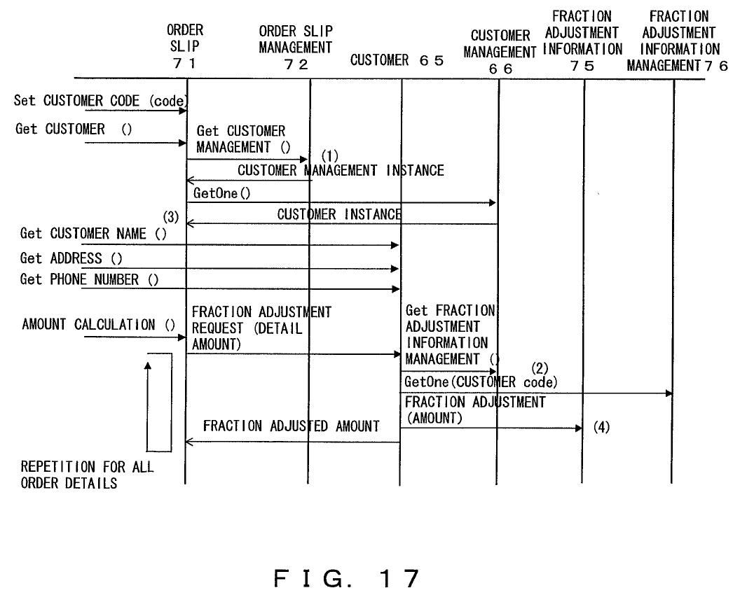

FIG. 17 shows one of the patterns of operations performed by these objects. In this example, a pattern of establishing the links shown in FIG. 16 is shown. First, on receipt of a message of Set customer code (code), the order slip 71 executes the Set customer code (code), and on receipt of a message of Get customer (), the order slip 71 executes the Get customer ().

At this time, the order slip 71 transmits a message of Get customer management () to the order slip management 72. The order slip management 72 executes the Get customer management (), acquires the instance of the customer management 66 using link (1) and returns the information to the order slip 71.

Then, the order slip 71 transmits a message of GetOne () to the customer management 66. The customer management 66 executes the GetOne (), acquires the instance of the customer 65 and returns the information to the order slip 71. A link to the instance of the customer 65 is stored in the instance of the order slip 71 as link (3).

Then, on receipt of messages of Get customer name (), Get address () and Get phone number (), the customer 65 executes the Get customer name (), Get address () and Get phone number ().

Then, on receipt of a message of amount calculation (), the order slip 71 executes the amount calculation () and transmits a message of fraction adjustment request (detail amount) to the customer 65. The customer 65 executes the fraction adjustment request (detail amount) and transmits a message of Get fraction adjustment information management () to the customer management 66. Then, the customer management 66 executes the Get fraction adjustment information management (),acquires the instance of the fraction adjustment information management 76 and returns the information to the customer 65.

Then, the customer 65 transmits a message of GetOne (customer code) to the fraction adjustment information management 76. The fraction adjustment information management 76 executes the GetOne (customer code), acquires the instance of the fraction adjustment information 75 and returns the information to the customer 65. A link to this instance of the fraction adjustment information 75 is stored in the instance of the customer 65 as link (4) until the amount calculation of the order slip 71 is completed.

Then, the customer 65 transmits a message of fraction adjustment (amount) to the fraction adjustment information 75. The fraction adjustment information 75 executes the fraction adjustment (amount) and returns the adjusted amount to the customer 65. Then, the customer 65 transmits the returned amount to the order slip 71 as a fraction adjusted amount. In this way, the amount calculation of one order detail 44 is completed.

Such a calculation is repeated times equivalent to the number of the order details 44, and when the process of all the order details 44 are completed, the amount calculation of the order slip 71 is completed. Since link (4) to the instance of the fraction adjustment information 75 is stored in the customer 65 until the amount calculation of the order slip 71 is completed, reference to the fraction adjustment information management 76 is made only at the first time.

An object management can store the following method groups as interfaces in addition to the methods described in the above-described patterns.

(1) A method group which designates the retrieval conditions of a domain object (Select/Get)

Select () includes a retrieval condition as an argument, retrieves a plurality of records in one communication with a database (SQL execution) and stores the retrieval result in the memory area of an object management. Get () is used in pairs with Select (), and one domain object is returned by executing Get (). At this time, the object management extracts data equivalent to one domain object from data pooled at the time of Select () execution, and creates a domain object.

When the object management conceals a database, it is more efficient to use these methods than to individually acquire domain objects using GetOne () if records to be processed can be extracted in a batch under a specific retrieval condition.

(2) A method group which designates a retrieval condition of a domain object and collectively returns all the attribute information of corresponding instances (Select/GetAllAttributes)

(3) A method group which designates a retrieval condition of a domain object, sequentially returns corresponding instances and collectively updates a database after modifying the attribute information of the instances (Select/Get/Update)

(4) A method group which collectively registers all the instances of a plurality of newly created domain objects (Alloc/Insert/Flush)

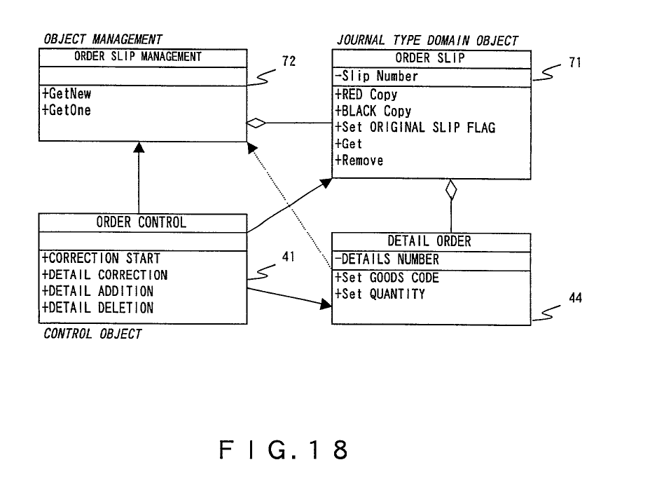

FIG. 18 shows link relationships among objects for explaining the high-level method of a control object. A control object stores a high-level method which does not belong to a specific domain object. The high-level methods are as follows.

(1) An order is issued when an order is received.

(2) An inventory allocation is carried out when an order is received.

(3) A red (correction) slip is registered when the order is corrected.

(4) Sales amount calculation is carried out every time an order is received.

In an online business, a control object executes a process request from a client using stored links and notifies the client of the process result. At this time, the control object expands a message from the client to a plurality of messages which belong to the same class, and transmits the messages. Since the control object can simultaneously handle a plurality of instances which belong to the same class, a batch process can also be described.

The order control 41 stores links to the order slip management 72, order slip 71 and order detail 44. The order slip management 72 and the order slip 71 are in an aggregate relationship, and the order slip 71 and the order detail 44 are in an aggregate relationship. The order detail 44 uses the order slip management 72.

In this example, the order slip management 72 stores “GetNew” and “GetOne” as methods. The order slip 71 stores “slip number” as an attribute and stores “red Copy”, “black Copy”, “Set original slip flag”, “Get” and “Remove” as methods. The order control 41 stores “correction start”, “detail correction”, “detail addition” and “detail deletion” as methods. The order detail 44 stores “detail number” as an attribute and stores “Set goods code” and “Set quantity” as methods.

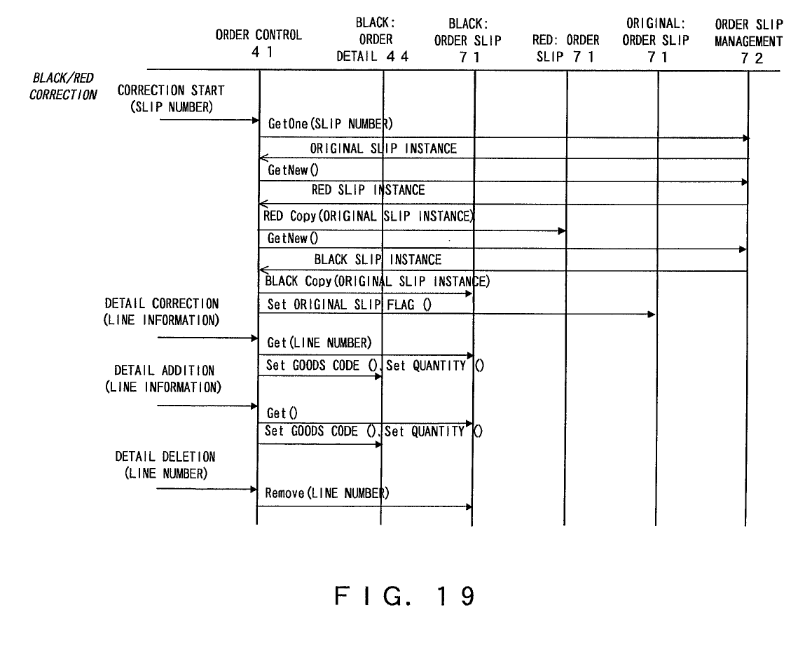

FIG. 19 shows one of the patterns of operations performed by these objects. In this example, a pattern of making black/red correction. First, on receipt of a message of correction start, the order control 41 executes correction start () and transmits a message of GetOne (slip number) to the order slip management 72. The order slip management 72 executes the GetOne (slip number), acquires the instance (original slip) of the order slip 71 and returns the information to the order control 41.

Then, the order control 41 transmits a message of GetNew () to the order slip management 72. The order slip management 72 executes the GetNew (), creates the instance (red slip) of the order slip 71 and returns the information to the order control 41. Then, the order control 41 transmits a message of red Copy (original slip instance) to a red slip instance, and the red slip instance executes the red Copy (original slip instance).

Then, the order control 41 transmits a message of the GetNew () to the order slip management 72. The order slip management 72 executes the GetNew (), creates the instance (black slip) of the order slip 71 and returns the information to the order control 41. Then, the order control 41 transmits a message of black Copy (original slip instance) to a black slip instance, and the black slip instance executes the black Copy (original slip instance).

Then, the order control 41 transmits a message of Set original slip flag () to an original slip instance, and the original slip instance executes the Set original slip flag ().

Then, on receipt of a message of detail correction (line information), the order control 41 executes the detail correction (line information) and transmits a message of Get (line number) to a black slip instance. The black slip instance executes the Get (line number), acquires the instance of a corresponding order detail 44 and returns the information to the order control 41. Then, the order control 41 transmits messages of Set goods code () and Set quantity () to the order detail 44. The order detail 44 executes the Set goods code () and Set quantity (), and corrects the goods code and quantity.

On receipt of a message of detail addition (line information), the order control 41 executes the detail addition (line information) and transmits a message of Get () to the black slip instance. The black slip instance executes the Get (), creates the instance of the order detail 44 and returns the information to the order control 41. Then, the order control 41 transmits a messages of the Set goods code () and Set quantity () to the order detail 44. The order detail 44 executes the Set goods code () and Set quantity () and sets both a goods code and the quantity.

On receipt of a message of detail deletion (line number), the order control 41 executes the detail deletion (line number) and transmits a message of Remove (line number) to the black slip instance. The black slip instance executes the Remove (line number) and deletes a corresponding line.

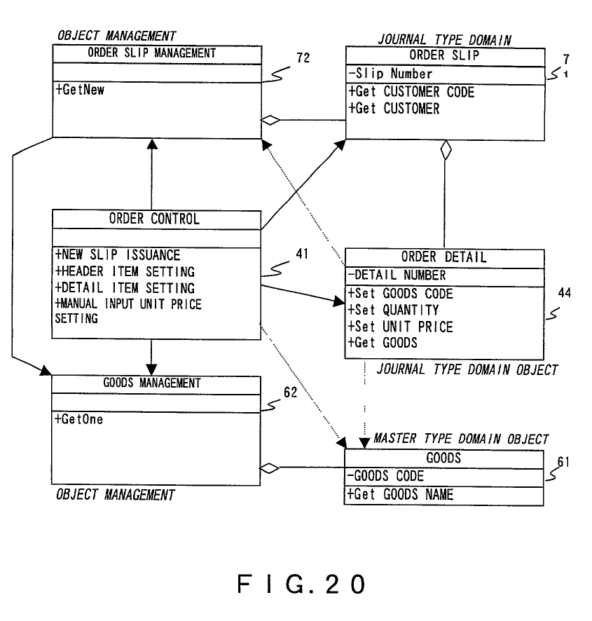

FIG. 20 shows link relationships among objects for explaining the link control between the instances of a control object. Although the control object is created and held by a director, at that time, links to necessary journal and master type object managements are established. The control object stores both a business rule required to execute a process request from a client and links between instances required to execute the request.

The order slip management 72 stores a link to a goods management 62, and the order control 41 stores a link to the order slip management 72. The order slip management 72 and the order slip 71 are in an aggregate relationship, and the goods management 62 and the goods 61 are in an aggregate relationship. Furthermore, the order slip 71 and the order detail 44 are in an aggregate relationship. The order control 41 uses the order slip 71, order detail 44 and goods 61, and the order detail 44 uses the order slip management 72 and goods 61.

In this example, the order slip management 72 stores “GetNew” as a method. The order slip 71 stores “slip number” as an attribute and stores “Set customer code” and “Get customer” as methods. The order control 41 stores “new slip issuance”, “header item setting”, “detail item setting” and “manual input unit price setting” as methods. The order detail 44 stores “detail number” as an attribute and stores “Set goods code”, “Set quantity”, “Set unit price” and “Get goods” as methods.

The goods management 62 stores “GetOne” as a method. The goods 61 stores “goods code” as an attribute and stores “Get goods name” as a method.

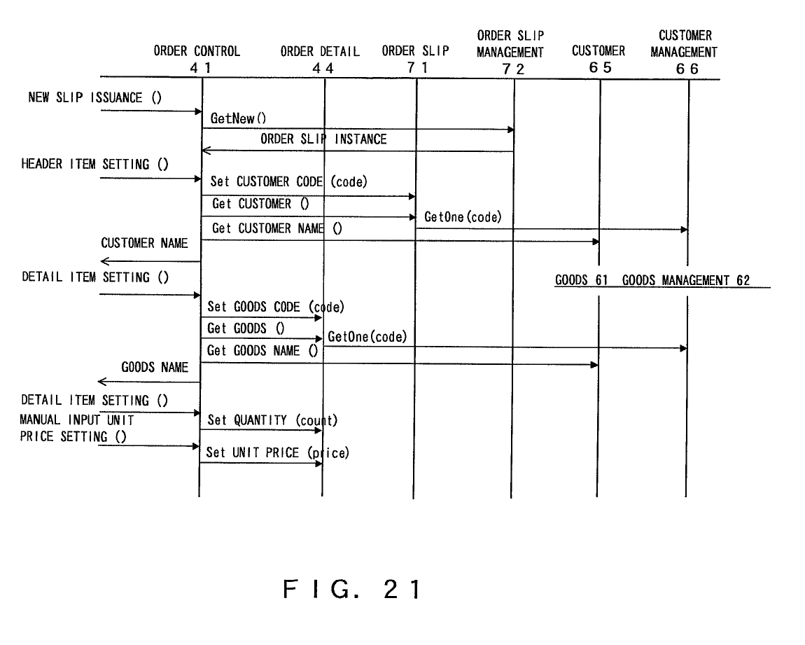

FIG. 21 shows one of the patterns of operations performed by these objects. In this example, a pattern of issuing an order slip 71 and setting the items of an order detail 44 is shown.

First, on receipt of a message of new slip issuance () the order control 41 executes the new slip issuance () and transmits a message of GetNew () to an order slip management 72. The order slip management 72 executes the GetNew (), creates the instance of an order slip 71 and returns the information to the order control 41. In this way, the order control 41 acquires a link to the order slip 71.

Then, on receipt of a message of header item setting (), the order control 41 executes the header item setting () and transmits a message of Set customer code (code) to the order slip 71. Then, the order slip 71 executes the Set customer code (code) and sets a customer code.

Then, the order control 41 transmits a message of Get customer () to the order slip 71. The order slip 71 executes the Get customer () and transmits a message of GetOne (code) to the customer management 66 shown in FIG. 16. The customer management 66 executes the GetOne (code), acquires the instance of the customer shown in FIG. 16 and returns the information to the order slip 71. Then the order slip 71 transmits the returned information about the instance of the customer 65 to the order control 41. In this way, the order control 41 acquires a link to the customer 65.

Then, the order control 41 transmits a message of Get customer name () to the customer 65. The customer 65 executes the Get customer name (), acquires a customer name and returns the customer name to the order control 41. Then, the order control 41 notifies a client of the returned customer name.

Then, on receipt of a message of detailed item setting (), the order control 41 executes the detail item setting () and transmits a message of Set goods code (code) to the order detail 44. Then, the order detail 44 executes the Set goods code (code) and sets a goods code.

Then, the order control 41 transmits a message of Get goods () to the order detail 44. The order detail 44 executes the Get goods () and transmits a message of GetOne (code) to the goods management 62. The goods management 62 executes the GetOne (code), acquires the instance of the goods 61 and returns the information to the order detail 44. Then, the order detail 44 transmits the returned information about the instance of the goods 61 to the order control 41. In this way, the order control 41 acquires a link to the goods 61.

Then, the order control 41 transmits a message of Get goods name () to the goods 61. The goods 61 executes the Get goods name (), acquires a goods name and returns the goods name to the order control 41. Then, the order control 41 notifies the client of the returned goods name.

Then, on receipt of a message of detail item setting () the order control 41 executes the detail item setting () and transmits a message of Set quantity (count) to the order detail 44. Then, the order detail 44 executes the Set quantity (count) and sets quantity.

Then, on receipt of a message of manual input unit price setting (), the order control 41 executes the manual input unit price setting () and transmits a message of Set unit price (price) to the order detail 44. Then, the order detail 44 executes the Set unit price (price) and sets a unit price.

A predetermined rule is applied to the setting of each item, and if there is an error in a set value, an error code is returned from an object which has executed the setting, to the order control 41. Then, the order control 41 executes a collective error process.

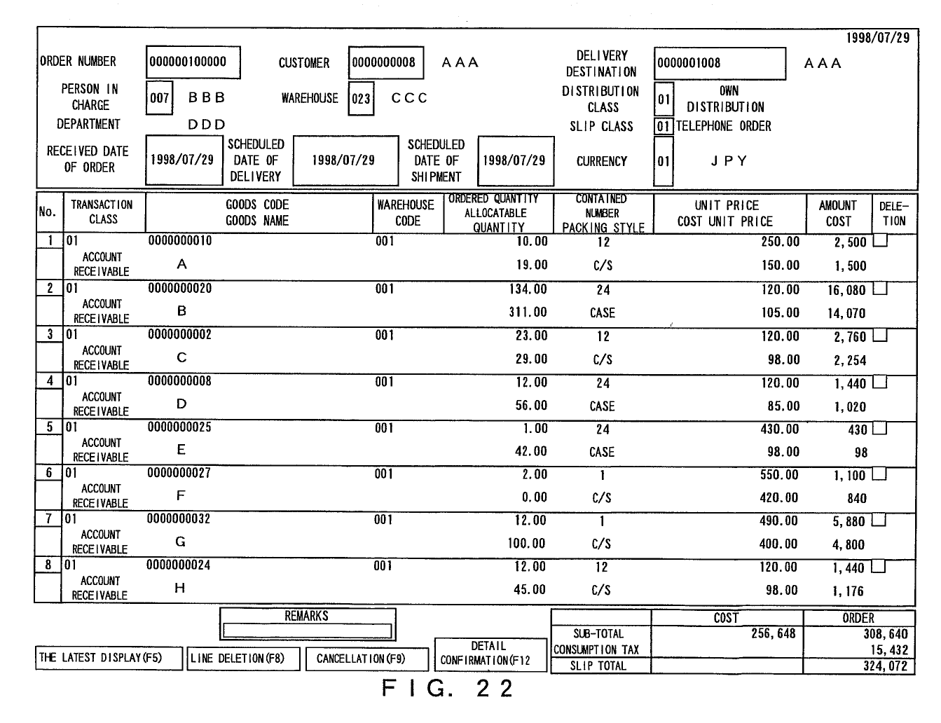

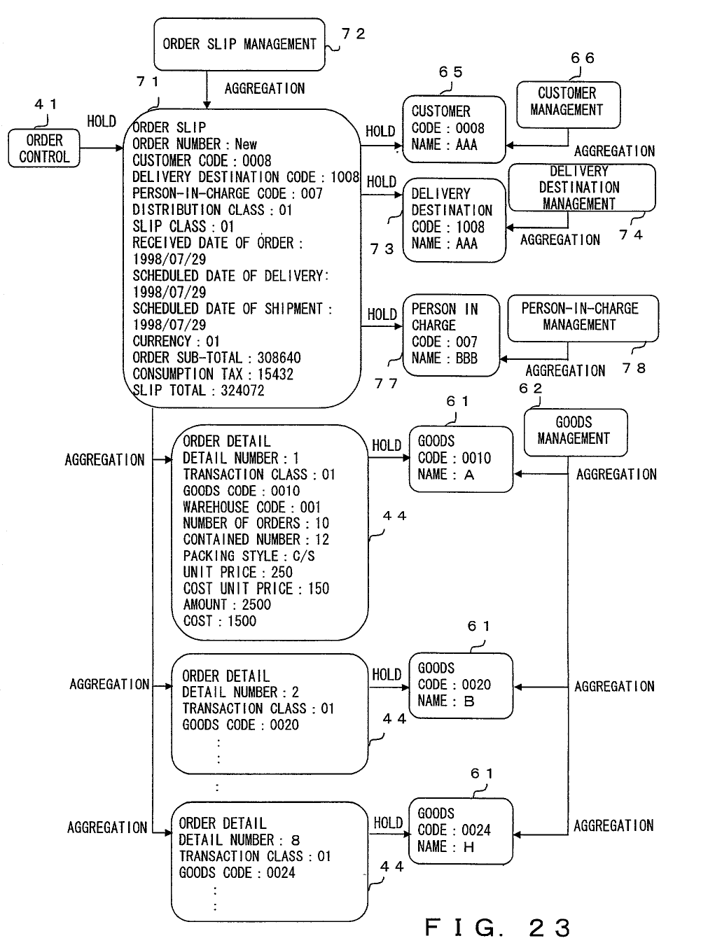

FIG. 22 shows an execution screen at the time of order input in a slip processing system, and FIG. 23 shows link relationships among corresponding instances. The information about items, such as an order number, customer, delivery destination, etc., displayed on the screen shown in FIG. 22 are distributed among and stored in a plurality of the instances shown in FIG. 23.

In FIG. 23, a person in charge 77 is a domain object, and a person-in-charge management 78 is the object management of the person in charge 77. The order control 41 stores a link to the order slip 71, and the order slip 71 stores links to the customer 65, delivery destination 73 and person-in-charge 77. The order detail 44 stores a link to the goods 61.

The order slip management 72 and the order slip 71 are in an aggregate relationship, and the order slip 71 and the order detail 44 are in an aggregate relationship. The goods management 62 and the goods 61 are in an aggregate relationship. The customer management 66 and the customer 65 are in an aggregate relationship, and the delivery management 74 and the delivery destination 73 are in an aggregate relationship. The person-in-charge management 78 and the person in charge 77 are in an aggregate relationship.

The order slip 71 stores attributes, such as an order number, customer code, delivery destination code, person-in-charge code, etc., and the customer 65 stores attributes of a customer code and a customer name. The delivery destination 73 stores attributes of a delivery destination code and a delivery destination name, and the person-in-charge 77 stores attributes of a person-in-charge code and a person-in-charge name. The order detail 44 stores attributes, such as detail number, transaction class, goods code, etc., and the goods 61 stores attributes of a goods code and a goods name.

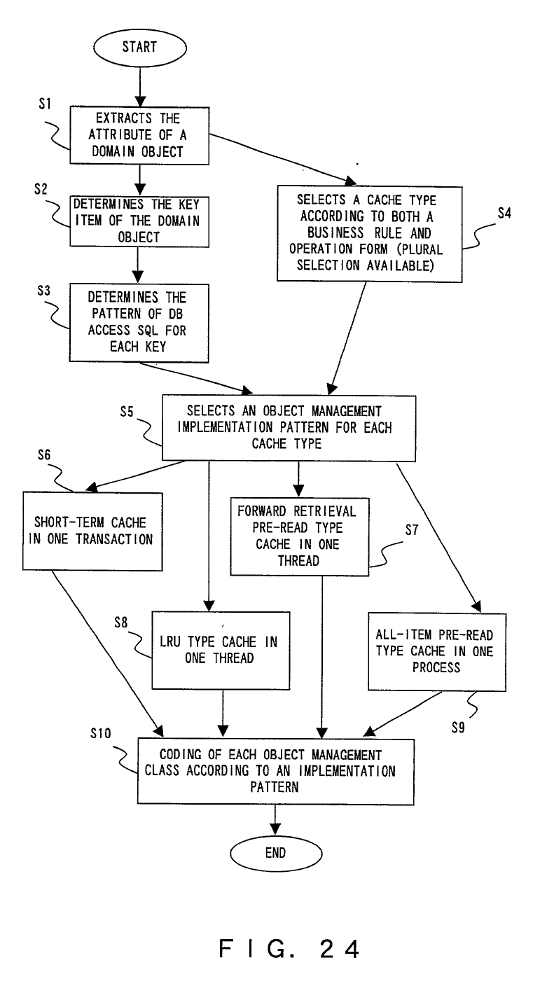

FIG. 24 shows the class creating procedure of an object management. The business system first extracts the attribute of a domain object (step S1), determines the key items of the domain object (step S2) and determines the SQL pattern of a database access for each key item (step S3). For the key items, for example, the code and name of a domain object are used.

The cache type of data is selected according to the business rule and the operation form of the system (step S4). A cache is, for example, provided in the memory of the business system, and one or more cache types can be selected. For the cache types, for example, the following types are used.

(1) A short-term cache in one transaction: A domain object is stored in the cache until one transaction of a process is completed.

(2) An LRU (least recently used) cache in one thread: A domain object is stored in the cache until one thread of process is completed and a domain object to be replaced in the cache is determined by LRU method. A thread is a process unit composing a process (task) LRU method is an algorithm for leaving recently used data in a cache and selecting data which have not used for the longest time as replacement targets. Therefore, a group of selected objects are stored in a cache in order of more recently accessed until the cache is filled with the group of objects, and thereby the use efficiency is improved.

(3) A forward retrieval pre-read type cache in one thread: First, a specific number of domain objects are read in advance from an auxiliary storage device in ascending or descending order with priority to a domain object with a key designated by GetOne () as an attribute. When the process is completed, the domain objects read from the cache are released. Then, when the cache becomes empty, the next specific number of domain objects are read in the cache in advance.

(4) An all-item pre-read type cache in one process: When a process is started, all domain objects to be processed are read in advance in a cache from an auxiliary storage device. Then, the domain objects are stored in the cache until the process is completed.

Then, the business system selects the implementation pattern of an object management for each cache type (step S5). In step S6, the implementation pattern for a short-term cache in one transaction is selected, and in step S7, the implementation pattern for an LRU cache in one thread is selected. In step S8, the implementation pattern for a forward retrieval pre-read type cache in one thread is selected, and in step S9, the implementation pattern for an all-item pre-read type cache in one process is selected.

Then, the business system encodes the class of each object management based on the implementation pattern (step S10) and then the creation process is terminated.

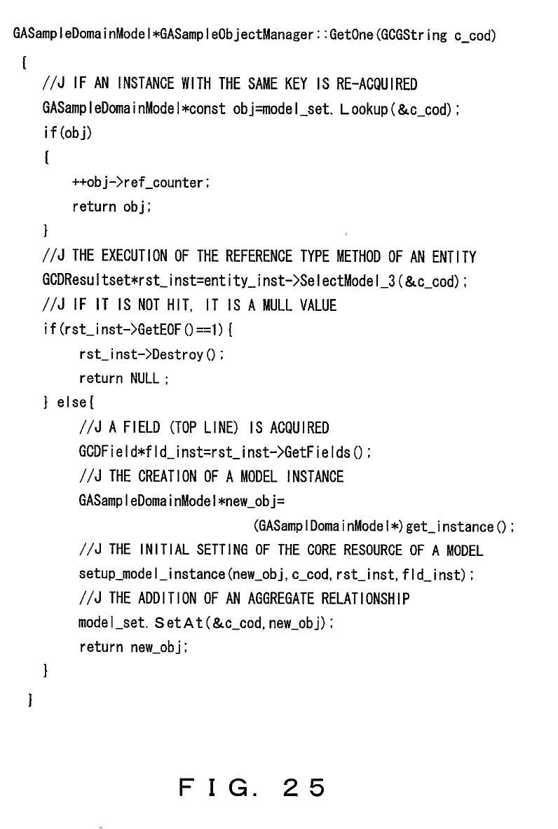

FIGS. 25 through 27 are examples of the implementation patterns of methods used in the business system. FIG. 25 is the implementation pattern of GetOne () which obtains a domain object. This implementation pattern is common to a short-term cache and an LRU cache.

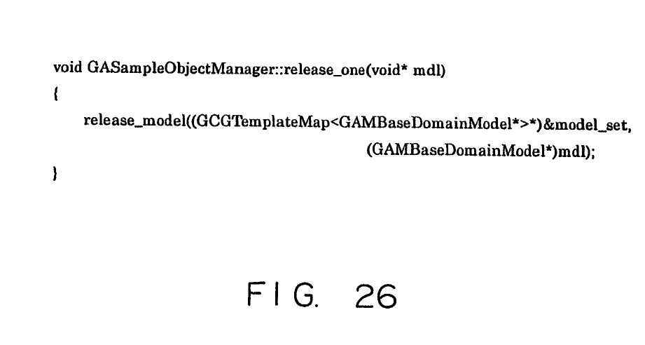

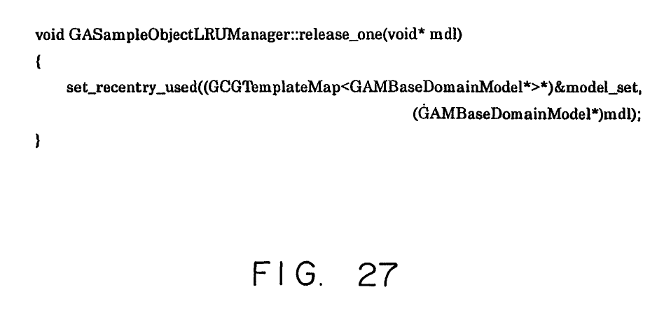

FIGS. 26 and 27 are the implementation patterns of release one releasing an object. FIG. 26 is a pattern for a short-term cache, and FIG. 27 is a pattern for an LRU cache. Release one is used, for example, when a domain object held by an object management is released from the memory.

The above-described business system shown in FIG. 2 can be configured using an information processing device (computer) as shown in FIG. 28. The information processing device shown in FIG. 28 comprises a CPU (central processing unit) 81, a memory 82, an input device 83, an output device 84, an external storage device 85 and a medium driver device 86 and a network connection device 87, which are connected with one another using a bus 88.

The memory 82 includes, for example, a ROM (read only memory), a RAM (random access memory), etc., and stores a program and data of objects to be used for the process. The CPU 81 executes necessary processes by running the program using the memory 82.

The input device 83 is, for example, a keyboard, a pointing device, touch panel or etc., and is used for a user to input instructions and information. The output device 84 is, for example, a display, printer, speaker or etc., and is used to output inquiries and information to a user.

The external storage device 85 is an auxiliary storage device, such as a magnetic disk device, optical disk device, magneto-optical disk device, etc., and stores the database 13 and sequential file 14 shown in FIG. 2. Both the above-described program and data are also stored in this external storage device, and can be used by downloading them to the memory 82, if required.

The medium driver device 86 drives a portable storage medium 89 and accesses the recorded content. For the portable storage medium 89, an arbitrary computer-readable storage medium, such as a memory card, floppy disk, CD-ROM (compact disk read only memory), optical disk, magneto-optical disk, etc., are used. Both the above-described program and data are also stored in this portable storage medium, and can be used by downloading them to the memory 82, if required.

The network connection device 87 communicates with an outside device via an arbitrary network (line), such as a LAN (local area network), etc., and transmits and receives data accompanying communications. Both the above-described program and data are also received from the outside device and can be used by downloading them to the memory 82, if required.

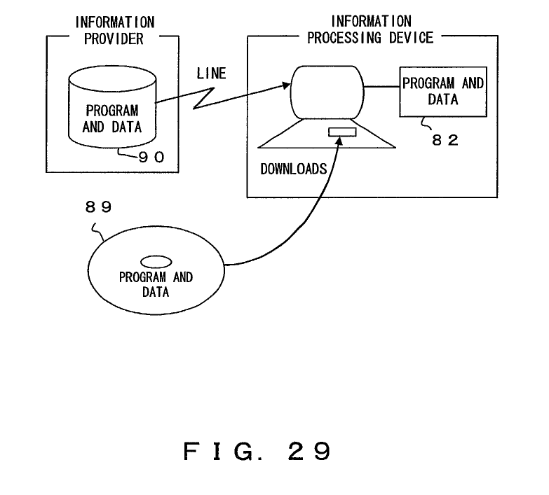

FIG. 29 shows computer-readable storage media which can supply the information processing device shown in FIG. 28 with a program and data. Both the program and data stored in the portable storage medium 89 or the external database 90 are downloaded to the memory 82. Then, the CPU 81 executes necessary processes by running the program and using the data.

According to the present invention, a business system utilizing the features of object-orientation can be organized. According to this system, since object-oriented components can be easily reused and combined, a variety of systems matched to the business form of a user can be organized on a basis of this system.

Since components to be corrected can be easily focussed according to the customization requirements of a user, the number of components to be corrected can be reduced. Since object-oriented components are used, data operation and the implementation of a business rule are concealed from an outside view. Furthermore, since all components are designed/implemented according to patterns, the maintainability of an entire system is improved.

Since each component is implemented according to patterns and taking inheritance into consideration, the development cost of components can be reduced compared with that of a conventional system. Furthermore, since the application ratio to components of implementation patterns is high, both the correction quality and productivity of components are improved.

What is claimed is:

1. A business system, comprising:
an object unit provided with a domain object storing a business rule, and an object management managing the domain object and implementing an interface for data access; and
an execution unit executing a process corresponding to the business rule using both the domain object and object management.

2. The business system according to claim 1, wherein the object management performs at least one operation of creation, deletion and hold of the domain object.

3. The business system according to claim 1, wherein the object management is provided with an interface suitable for at least one of a target of the data access and an access method, and is used in combination with the domain object.

4. The business system according to claim 3, wherein the object management is provided with an interface suitable for at least one of a cache and auxiliary storage device.

5. The business system according to claim 3, wherein the object management is provided with an interface suitable for at least one of an online process, a batch process and a master maintenance process.

6. The business system according to claim 1, wherein said object unit has a plurality of object managements depending on at least one of a target of data access and access method, and combines one of the plurality of object managements with the domain object.

7. The business system according to claim 1, wherein the object management is provided with an interface for designating a value of a key attribute of the domain object and returning a corresponding domain object.

8. The business system according to claim 1, wherein the object management is provided with an interface for designating a retrieval condition of the domain object and sequentially returning corresponding domain objects one by one.

9. The business system according to claim 1, wherein the object management is provided with an interface for designating a retrieval condition of the domain object and collectively returning all information about corresponding domain objects.

10. The business system according to claim 1, wherein the object management is provided with an interface for registering new domain objects one by one.

11. The business system according to claim 1, wherein the object management is provided with an interface for collectively registering new domain objects.

12. The business system according to claim 1, wherein the object management is provided with an interface for updating domain objects one by one.

13. The business system according to claim 1, wherein the object management is provided with an interface for designating a retrieval condition of the domain object, sequentially returning corresponding domain objects one by one and collectively updating a database after the returned domain objects are modified.

14. The business system according to claim 1, wherein the object management keeps holding the domain object, and when an acquisition request for the domain object is received, the object management immediately returns the domain object.

15. The business system according to claim 1, wherein when the object management keeps holding a plurality of domain objects, the object management manages the plurality of domain objects according to a specific algorithm concerning memory efficiency.

16. The business system according to claim 1, wherein the object management acquires in advance all domain objects to be processed and on receipt of an acquisition request for a domain object, the object management immediately returns a requested domain object.

17. The business system according to claim 1, wherein the object management acquires a specific number of domain objects from a domain object with a value of a key attribute designated in the first place, in a specific order in advance, and on receipt of an acquisition request for one of the specific number of domain objects, the object management immediately returns a requested domain object.

18. The business system according to claim 1, wherein said object unit is further provided with a control object controlling a collaboration relationship between the domain object and object management.

19. The business system according to claim 1, wherein said object unit is further provided with a service object providing the domain object with a service.

20. The business system according to claim 19, wherein the service object is provided with an interface for incorporating a business rule designated by a user.

21. A business system, comprising:
an object unit provided with a control object jointing a plurality of objects with a high abstraction degree and a small grain size, and controlling a process corresponding to an application; and
an execution unit executing the process corresponding to the application using the control object.

22. A computer-readable storage medium on which is recorded an object-oriented program, comprising:
a domain object which is provided with a business rule procedure;
an object management which manages the domain object and is provided with a data access procedure for executing the business rule.

23. A business process method, comprising:
separating a domain object storing a business rule from an object management managing the domain object and provided with an interface for data access, and;
executing a process corresponding to the business rule using the domain object and object management; and
notifying a process result.

24. A business system, comprising:
object means provided with a domain object storing a business rule, and an object management managing the domain object and implementing an interface for data access; and
execution means for executing a process corresponding to the business rule using both the domain object and object management.
